(19) United States
(12) Patent Application Publication
(10) Pub. No.: US 2010/0018642 A1
(43) Pub. Date: Jan. 28, 2010

(54) METHOD FOR PRODUCING PANELS CONSISTING OF AN EXPANDED RENEWABLE MATERIAL, AND ASSOCIATED DEVICE

(75) Inventors: Marc Lanciaux, Layrac (FR); Benjamin Lanciaux, Agen (FR)

Correspondence Address: Pepper Hamilton LLP, 400 Berwyn Park, 899 Cassatt Road, Berwyn, PA, 19312-1183, US

(73) Assignee: BIO CREATION, Estillac (FR)

(21) Appl. No.: 12/526,802

(22) PCT Filed: Feb. 12, 2008
(86) PCT No.: PCT/FR2008/050212

§ 371 Date: Aug. 12, 2009

(30) Foreign Application Priority Data
Feb. 12, 2007 (FR) 07 00966

(51) Int. Cl. B29C 47/78; B32B 37/10

(52) U.S. Cl. 156/244.22; 156/382

(57) ABSTRACT

The invention relates to methods for making panels of an expanded renewable material, essentially starch, characterised in that it comprises: extruding unit members or strings having a small section and a substantial length L; assembling by juxtaposing and gluing these strings thus obtained along their longitudinal axis in order to produce a layer having a width A; superimposing and assembling by gluing at least two of said string layers in order to produce a block having a height B and a length L, said block thus exhibiting a section with a side A and a side B having dimensions related to the number of assembled unit members; and cutting said block transversally relative to the longitudinal axis along a length l in order to obtain plates having a maximal section of A×B with a selected thickness l. The invention also relates to a related device.

The present invention concerns a method for producing a large-size panel in renewable material. The invention also covers an associated device to produce this panel.

Panels in foam material are known, used in very numerous applications such as building insulation or in any other sector.

Existing panels contain expanded foam of synthetic chemical compounds such as polystyrenes or polyurethanes.

The characteristics of these foams can be fully controlled such as mechanical, density and pore size characteristics for example.

These panels can also be produced from expanded beads glued together within a mould, which allows glued bead panels to be obtained.

While production is fully industrialised said panels have a disadvantage which is becoming increasingly unacceptable: the material used is of petroleum origin and is hence a non-renewable material.

On the other hand, compositions are known which are derived from biodegradable materials, especially of plant origin and hence renewable, but in this case the problem which arises is the production of large-size and/or wide-thickness panels.

The present invention sets out to propose a method to produce large-size and/or wide-thickness panels from renewable materials of plant origin and biodegradable.

The remainder of the description is based on a composition containing starch foam for illustration of the method, irrespective of the origin of this starch. The invention also covers any similar renewable material of plant origin which is biodegradable and has the same behaviour.

When starch is formed to produce industrial items, hence in large quantities with high reproducibility and precise dimensional constants, numerous problems arise.

One well-known means of producing a product from starch foam consists of extruding the composition through a die under very high pressure, using a screw extruder.

Extrusion pressure is very high, in the order of 80 to 120 bars.

The calibrated die must impart final shape to the foam, but there is very strong expansion of the foam as it leaves the die, when the foam is only subjected to atmospheric pressure, caused by vaporisation of the water contained in said composition.

Having regard to the pressures used and having regard to this expansion which is difficult to control, the dimensions of extruded products are limited to strips a few centimetres wide, e.g. 20 cm, and a few centimetres thick e.g. 1 cm for the given width of 20 cm.

As soon as the cross-sections of the extruded profiles increase in size, the problems become difficult to solve:
evacuation of the water vapour generated at the exit of the die,
variations in cross-sectional expansion due to preferred passageways through the die,
undesirable or at least uncontrolled shrinkage, leading to deformed extruded profiles,
guiding a product having random deformations, extruded at high speed in the order of 2 metres per second to indicate an order of magnitude.

To date, there are no methods or means to extrude large-size and/or wide-thickness panels industrially at a high production rate and with adapted reproducibility of given dimensions.

The method of the invention sets out to remedy this problem by proposing a method to produce large-size and/or wide-thickness panels in an expanded material containing a composition of renewable material, of plant origin such as starch, a method which comprises the succession of following steps:
using extrusion to produce unit elements or rods of small cross-section and long length L,
assembling these manufactured rods side by side, by gluing along their longitudinal axis to form a layer of width A,
superimposing and assembling at least two layers of rods by gluing to form a block of height B, length L equal to the length of the unit elements, the block therefore having a cross-section with a side A and a side B whose size is related to the number of assembled unit elements, and
cutting this block crosswise relative to the longitudinal axis over a length l to obtain panels of maximum section A×B and of chosen thickness l.

Each unit element is of appropriate size to allow instant evacuation of released water vapour. For example, for a potato starch-based composition, a rod having a cross-section of three centimetres is suitable.

The small cross-section of the unit element thus produced requires an extruding machine working at acceptable pressures well below the prior art pressures of 80 and even more than 100 bars.

The geometry of the rod cross-section must also be such that it is symmetrical relative to the centre so as to avoid distortions.

To optimize longitudinal gluing of the rods in the following phase of the method, the connecting surface hence the gluing surface must be optimized.

An optimized cross-section, considered to be a preferred embodiment of the present invention, consists of producing rods having a hexagonal cross-section.

Advantageously the rods of one same layer are glued via two opposite surfaces so as to obtain two edges in the vertical plane, and the superimposed layers are staggered by a rod semi-section on either side alternately to allow perfect interlocking.

The method to produce a panel according to the present invention allows all sizes of panels A×B to be obtained, these dimensions resulting from the number of assembled rods and the chosen thickness l, length L allowing a wide choice of thicknesses.

On the other hand, rods must be obtained that are perfectly calibrated and of accurate dimensions for perfect assembly of the rods in one same layer and for assembly of each layer to form a block, in particular in the preferred embodiment i.e. using rods of hexagonal cross-section.

The speed of a rod leaving the die of the extruding machine is around 2 m/s and the temperature for a starch-based composition is 150° C. When the extruded rod leaves the die, although it is of small size, it is necessary to control its expansion which occurs a few tenths of a second after it leaves the die.

Therefore the method of the invention provides for a rod calibration step. This calibration step consists of causing the rod, after it leaves the extruding machine, to pass through a conforming chamber having the profile and exact dimensions of the rod it is desired to obtain.

According to an improvement on the method of the present invention, for improved expansion within this conforming chamber and to avoid expansion outside this chamber, the rod is subjected to an energy field and more particularly an electromagnetic wave field.

The gases contained in the rod are then rapidly depressurized under the action of this supply of energy, and cause maximum integral expansion of the rod within the conforming chamber.

To give an example of a conforming chamber such as provided in the embodiment of the device according to the present invention, a chamber in porous material can be cited such as obtained from polytetrafluoroethylene. It is also possible to create one or more successive portions along this conforming chamber which are subjected either to hot air pressure to form an air cushion, or to depressurization to remove the released water vapour subsequent to expansion.

The rod thus conformed is still at a high temperature, in the order of one hundred degrees and hence is flexible and deformable.

Therefore the method of the present invention provides for a cooling step with simultaneous calibration on leaving the conforming chamber.

This cooling step with calibration is performed by passing the rod through a dynamic cooling former.

Said dynamic cooling former, in the embodiment of the device according to the present invention, consists of at least one set of metal belts mobile in translation along the longitudinal working axis.

Each belt corresponds to a side of the rod under consideration, hence six belts are provided corresponding to the six sides of the hexagonal profile.

Alignment is in line with the calibration chamber and the conforming chamber, to maintain a perfectly straight profile.

It is noted that the speed of the belts must be adapted and must be slightly lower than the exit speed of the rod from the calibration and conforming chambers, since rod shrinkage occurs during cooling and hence a reduction in length. A speed that is identical to the speed of the rod as it leaves the chambers could cause surface cracks on the rods due to a differential traction.

Since the speed along a belt cannot vary, it is advantageous according to a preferred variant of embodiment of the device, to provide for a succession of several sets of belts, each set having a different speed with rod take-up.

To obtain rapid cooling of the rod sides and to fix its dimensions, the belts are air cooled over their return portion since each belt face in contact with the corresponding side of the rod is directly accessible on this return portion.

Once cooled, the rod must be cut to length L.

Having regard to the travel speed, on-the-fly cutting must be ensured to obtain a clean cut and to limit losses as much as possible.

One element of the device consists of having recourse either to laser cutting means or to a hyper bar water jet with alternate movement of the cutting head. Said cutting means avoid disturbing the travel movement of the rod which therefore does not undergo any mechanical stress.

The rod portion L thus cut must be collected and separated from the continuous rod leaving the dynamic cooling former.

The method of the present invention proposes a separation step via aspiration.

Means that are adapted to produce the device of the invention and allowing said application concern an assembly of at least two transfer tubes. Each transfer tube has an inner profile that is identical to that of the rod, and has the same dimensions as the rod to the nearest necessary clearance.

Therefore the first tube receives a rod and places it on the layer being formed, whilst the second tube in masked time collects the following rod and so on, either side of the centre of the layer to be formed.

Each tube may comprise several mobile sectors such as jaws so that it is able to release the rod contained in the tube. Therefore the sectors which might disturb depositing are retracted.

In this case the sectors which ensure holding of the rod are equipped with suction nozzles to hold the rod in place by a vacuum.

The gluing of the rods before they are applied to the layer can be achieved using any suitable means. One means is glue spraying.

In the preferred embodiment, the rods lie side by side in one same layer, and the layers interlock perfectly if they are staggered as mentioned above.

The method therefore allows a block to be formed of size A×B×L which theoretically has no limits but is nonetheless of several metres.

The block so produced can be used immediately for cutting into sections of dimensions A×B×l forming large-size panels and of chosen thickness possibly reaching several centimetres or tens of centimetres.

The extruding machine used only requires routine pressures to generate a rod having a cross-section of a few cm² through the die.

Since the core lies close to the surface, the release of gases and more particularly of water vapour is quicker and more complete, leading to great homogeneity of the material obtained.

The block consisting of homogeneous rods is therefore also homogeneous.

The gluing of said products is fully controlled and the mechanical resistance between rods is at least equal to the intrinsic resistance of the renewable material, which imparts mechanical homogeneity to the assembly.

The panels obtained can effectively be considered to be monolithic.

The surface condition of the panels is also satisfactory since it results from clean cutting of the block.

The proposed block has been defined as a parallelepiped, but it could assume shapes with a triangular section, substantially circular or oval section or of diabolo shape, since all that is required is to provide for the adapted superimposition of layers.

Said result is impossible to achieve directly from an extrusion die.

1-14. (canceled)

15. A method of producing panels in expanded renewable material comprising in succession:
producing rods by extrusion, wherein the rods comprise small section and a length L;
assembling the extruded rods side by side by gluing along their longitudinal axis to form a layer of width A;
superimposing and assembling at least two layers of rods by gluing to form a block of height B, length L, wherein the block comprises a cross-section with a side A and a side B whose size is related to the number of assembled rods; and
cutting the block crosswise relative to the longitudinal axis over a length l to obtain panels of maximum section A×B and of chosen thickness l.

16. The method according to claim 15 wherein the expanded renewable material is starch-based.

17. The method according to claim 15 wherein the rod is calibrated on leaving the extruder by causing it to pass through a conforming chamber comprising the exact profile and dimensions of the rod to be obtained.

18. The method according to claim 17 wherein the rod is subjected to an energy field so as to cause maximum full expansion of the rod under the action of this energy supply.

19. The method according to claim 17 wherein the rod is cooled with simultaneous dynamic calibration as it leaves the conforming chamber.

20. The method according to claim 18 wherein the rod is cooled with simultaneous dynamic calibration as it leaves the conforming chamber.

21. The method according to claim 19 wherein the dynamic calibration during cooling takes into account cooling-related shrinkage of the rod by reducing speed.

22. The method according to claim 20 wherein the dynamic calibration during cooling takes into account cooling-related shrinkage of the rod by reducing speed.

23. The method according to claim 19 wherein the extruded rod is cut to length L, collected, and separated from the continuous rod after cooling.

24. The method according to claim 20 wherein the extruded rod is cut to length L, collected, and separated from the continuous rod after cooling.

25. The method according to claim 21 wherein the extruded rod is cut to length L, collected, and separated from the continuous rod after cooling.

26. The method according to claim 22 wherein the extruded rod is cut to length L, collected, and separated from the continuous rod after cooling.

27. The method according to claim 23 wherein the rod is cut with no mechanical contact.

28. The method according to claim 24 wherein the rod is cut with no mechanical contact.

29. The method according to claim 25 wherein the rod is cut with no mechanical contact.

30. The method according to claim 26 wherein the rod is cut with no mechanical contact.

31. The method according to claim 15 wherein a hexagonal shape is given to the rod.

32. A device to produce panels in renewable material by implementing the method according to claim 17 comprising a conforming chamber at the exit of an extruding die, wherein the conforming chamber comprises the exact profile and dimensions of the rod to be obtained, and wherein the conforming chamber is made of a porous material.

33. The device according to claim 32 wherein the conforming chamber comprises portions subjected either to hot air pressure to form an air cushion or to depressurization to remove the released water vapour subsequent to expansion.

34. The device according to claim 32 wherein the conforming chamber comprises at least one set of metal belts, mobile in translation along a longitudinal working axis and whose number corresponds to the number of sides of an extruded rod.

35. The device according to claim 33 wherein the conforming chamber comprises at least one set of metal belts, mobile in translation along a longitudinal working axis and whose number corresponds to the number of sides of an extruded rod.

36. The device according to claim 34 wherein the belts comprise means to cool the belts.

37. The device according to claim 35 wherein the belts comprise means to cool the belts.

38. The device according to claim 34 further comprising several sets of belts, the speed of the belts decreasing from one set to another to take into account rod shrinkage during cooling.

39. The device according to claim 35 further comprising several sets of belts, the speed of the belts decreasing from one set to another to take into account rod shrinkage during cooling.

40. The device according to claim 36 further comprising several sets of belts, the speed of the belts decreasing from one set to another to take into account rod shrinkage during cooling.

41. The device according to claim 37 further comprising several sets of belts, the speed of the belts decreasing from one set to another to take into account rod shrinkage during cooling.

42. The device according to claim 32 further comprising an assembly of transfer tubes for collection of each rod and its positioning in the corresponding layer.
